(19) United States
(12) Patent Application Publication
(10) Pub. No.: US 2026/0285248 A1
(43) Pub. Date: Sep. 24, 2026

(54) TWO PIECE ELECTRIC VEHICLE CONTROL UNIT MOUNTING BRACKET

(71) Applicant: FCA US LLC, Auburn Hills, MI (US)

(72) Inventors: Ian T. GOODING, Auburn Hills, MI (US); Michael D. BROSOWSKI, Auburn Hills, MI (US); Raul E. ROMERO ROCHA, Mexico City (MX)

(21) Appl. No.: 19/086,237

(22) Filed: Mar. 21, 2025

(51) Int. Cl. B60R 16/023

(52) U.S. Cl. CPC B60R 16/0239

(57) ABSTRACT

A bracket for mounting an electrical vehicle control unit has a first bracket member with a body. The body receives the control unit. A first end has at least one tab to secure the first member to a support. A second end has at least one coupling flange. A second member couples with the at least one tab. A slot on the second member receives the tab. A lock on the second member secures with the tab. A body on the second member positions the second member with the support.

### FIELD

The present disclosure relates to electric vehicles and, more particularly, to a mounting bracket for an electrical vehicle control unit.

### BACKGROUND

This section provides background information related to the present disclosure which is not necessarily prior art.

As electric vehicles become more popular, manufacturers are tasked with dealing with the distribution of power in the vehicle. These electric vehicles necessitate high voltage structures and high voltage power distributions centers. The distribution centers have fuses at the bottom of the module that necessitate access when repair is required. Also, with putting the fuses at the bottom of the module, this forces the electric vehicle control unit to be mounted above them. Also, due to the mounting sequence in the vehicle, the design may result in a total lack of direct access to the electric vehicle control unit for service. Thus, the module is directly fastened to the housing which leaves the fasteners inaccessible when service is required and the fasteners must be removed. Removing or even accessing the electric vehicle control unit would require a total deconstruction of the surrounding skid plates, harshness and vibration modules, wiring, cooling and exhaust or removal of the body. Both are very lengthy and costly operations.

Accordingly, it is desirable to have an electric vehicle control unit that is accessible from the housing structure. Also, it is desirable to have a solution that is not only cost effective, but does not require additional tooling and that does not change the structure of the vehicle. Thus, it is desirable to provide the housing with a mechanism to enable full access to the electric vehicle control unit. The present disclosure provides such a feature for the electronic housing.

The present disclosure provides a bracket that enables removal of the electric vehicle control unit from the housing for repairs, replacement or the like. The present disclosure provides a fastenerless bracket portion at the blind end of the housing to enable removal of the accessible fasteners to enable the bracket to be removed from the housing like a cassette. Thus, the present disclosure enables the electric vehicle control unit to be pre-assembled to the bracket. This enables it to be inserted into the housing with support in the inaccessible area while providing securement access with standard fasteners to fully secure the bracket within the housing while still allowing room for electrical connections to be seated in the housing.

### SUMMARY

This section provides a general summary of the disclosure, and is not a comprehensive disclosure of its full scope or all of its features.

According to a first aspect of the disclosure, a bracket for mounting an electrical vehicle control unit comprises a first member with a body to receive the control unit. A first end has at least one tab to secure the first member to a support. A second end has at least one coupling flange to secure the bracket with the housing. A second member couples with at least one coupling tab. The second member includes a slot to receive the tab. A lock is on the second member to secure it with the tab. Also, the second member includes a body to position the second member within the housing support in an inaccessible area. The first body member includes posts to receive the control unit. The tab includes an aperture to receive and secure the lock. The lock includes a catch that inserts into the aperture to fastenerless couple of the first and second members together. The bracket is cantilevered in the support housing. The first end tab secures with the support.

According to a second aspect of the disclosure, an electric vehicle with a control unit housing comprises a housing support with surrounding walls to house electrical components. A bracket to mount the control unit is coupled with the housing. The bracket comprises a first member with a body to receive the control unit. A first end has at least one tab to secure the first member to a support. A second end has at least one coupling flange to secure the bracket with the housing. A second member couples with at least one coupling tab. The second member includes a slot to receive the tab. A lock is on the second member to secure it with the tab. Also, the second member includes a body to position the second member within the housing support in an inaccessible area. The first body member includes posts to receive the control unit. The tab includes an aperture to receive and secure the lock. The lock includes a catch that inserts into the aperture to fastenerless couple of the first and second members together. The bracket is cantilevered in the support housing. The first end tab secures with the support.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic perspective view of a housing for electrical components;

FIG. 2 is an exploded view of the mounting bracket; and

FIG. 3 is a cross-sectional view of the housing of FIG. 1.

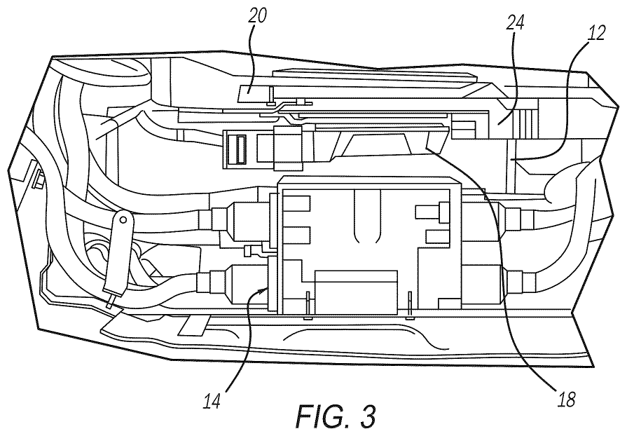

Corresponding reference numerals indicate corresponding parts throughout the several views of the drawings.

### DETAILED DESCRIPTION

Example embodiments will now be described more fully with reference to the accompanying drawings.

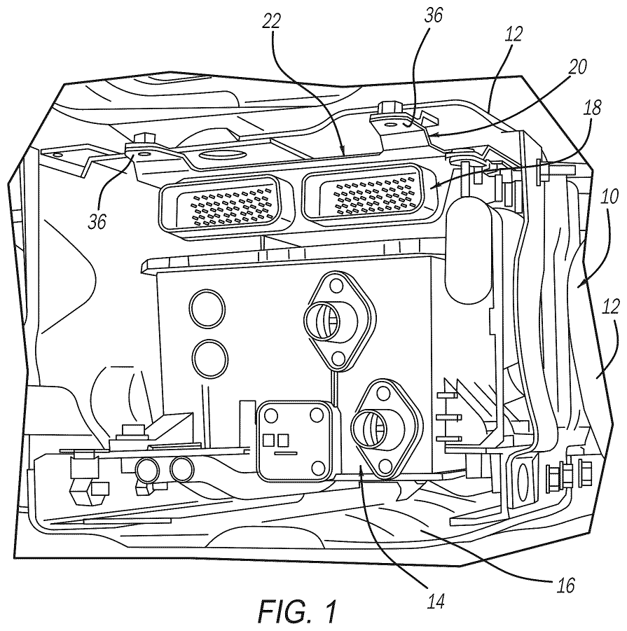

Turning to the figures, a housing 10 configured for receipt and support of various electrical components is illustrated in FIG. 1. Housing 10 may house various electrical components for an electric vehicle, but it should be understood that housing 10 may be used in any type of vehicle known to one skilled int eh art. Housing 10 includes a plurality of walls 12 surrounding various electrical components 14, including for example, fuse panels, high-voltage components, wires, and the like. A removable skid plate 16 is positioned beneath the housing walls 12. In the illustrated embodiment, housing 10 also house a vehicle electronic control unit (ECU) 18 that is positioned above the electrical components 14. The ECU 18 is secured with a bracket 20 that maintains the ECU 18 within the housing 10, while also enabling easy access and removal of the ECU 18 for service when necessary.

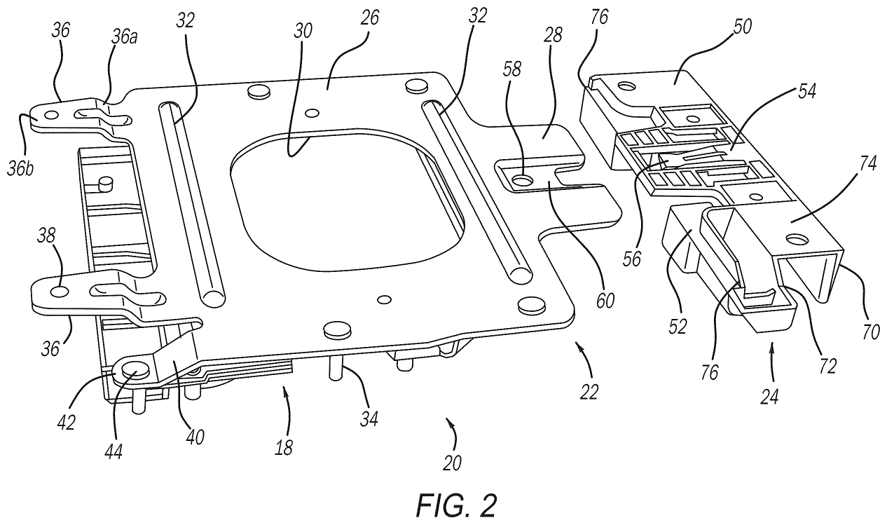

Now referring to FIG. 2, bracket 20 includes a first bracket member 22 and a second bracket member 24. The first bracket member 22 includes a body 26 with an extending tab 28. Generally, the body 26 is planar including a centrally positioned aperture 30 and reinforcement ribs 32. Also, the body 26 includes a plurality of posts 34 that project from the body 26 and are configured to mate with ECU 18 to secure ECU 18 to first bracket member 22. The body 26 has an overall rectangular configuration with the tab 28 extending from one side and a pair of securing flanges 36 extending from the opposite side. The flanges 36 have an overall L-shape with a short leg 36a extending away from the body 22 and a long leg 36b connected to and extending away from the short leg 36a.

Long legs 36b include a securement aperture 38 configured for receipt of a fastener to secure the bracket 20 relative to housing 10. Also, the body 26 includes a downward-extending tab 40 that is angled relative to body 26 and includes a tip 42 that receives a fastener 44 that secures with the ECU 18 to first bracket 22.

The second bracket member 24 includes a body 50 that defines a slot 52 that is configured to receive and mate with the tab 28 of first bracket member 22. The second bracket member 24 may be formed of a polymeric material, and includes a lock 54 that is cantilevered from the body 50 and includes a catch 56 that is received in an aperture 58 provided in the tab 28. This enables the second bracket member 24 to be secured with the tab 28 in a fastenerless manner. The lock 54 is a cantilevered arm with the catch 56. Thus, the arm can ride along the recess 60 in the tab 28 until the catch 56 engages the aperture 58. This locks the second bracket member 24 with the first bracket 22.

The second bracket member 24 is positioned in the housing 10 so that it is supported in an aperture (not shown) in the housing 10. The body 50 has an overall U-shape with a pair of legs 70, 72 as well as a web 74. Generally, the leg 72 engages the aperture in the housing 10 to support the bracket 20 on its one (inaccessible) side. The leg 72 can include additional supports 76 which act to position the second bracket member 24 in place in the housing 10. The second bracket member 24 is positioned in the housing 10 in an inaccessible area. Thus, the bracket 20 is only secured with the housing 10 at the front flanges 36 via the apertures 38. Thus, the bracket 20, upon loosening or removal of the fasteners, can be removed from the housing 10 in a cassette-like manner.

The installation and removal of the bracket 20 is entirely handled at the one side of the bracket 20. Put another way, second bracket 24 is mated with housing 10 and housing 10 including the electrical components 14 can be attached to the vehicle. Then, the ECU 18 may be secured to the first bracket 22 and the combination of the first bracket 22 and ECU 18 can be inserted into the housing 10 such that the extending tab 28 mates with the lock 54, and then fasteners (not shown) can be used to secure the flanges 36 to housing 10. This is ideal because the rear section of the housing 10 where second bracket 24 is located is not accessible unless substantial removable of various panels and features of the vehicle are removed to provide access to the rear of the housing 10. Accordingly, to service ECU 18, a technician merely needs to get access to flanges 36, remove the fasteners (not shown) that secure the flanges 36 to housing 10, and slide first bracket 22 away from second bracket 24, at which time lock 54 will disengage from aperture 58 of tab 28. This enables removal of fasteners on one side and the bracket 20 to be pulled out or removed from the housing 10. Also, this keeps the interface of the second bracket member 24 while providing support and structure at the rear or second end of the housing 10 without requiring easy access once the vehicle is completed. This enables service personnel to remove the required plates and connection and then remove the two front fasteners and slide the module out for repair.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A bracket for mounting an electrical vehicle control unit comprising:
a first bracket member having a body, the body for receiving the control unit, a first end having at least one tab for securing the first member to a support, a second end having at least one coupling flange;
a second member for coupling with the at least one tab;
a slot on the second member for receiving the tab;
a lock on the second member for securing with the tab; and
a body on the second member for positioning the second member with the support.

2. The bracket for mounting an electrical vehicle control unit of claim 1, wherein the first member body includes posts for receiving the control unit.

3. The bracket for mounting an electrical vehicle control unit of claim 1, wherein the tab includes an aperture for receiving and securing the lock.

4. The bracket for mounting an electrical vehicle control unit of claim 1, wherein the lock includes a catch that inserts into an aperture for fastenerless coupling of the first and second members.

5. The bracket for mounting an electrical vehicle control unit of claim 1, wherein the bracket is cantilevered in the support.

6. The bracket for mounting an electrical vehicle control unit of claim 1, wherein only the first end flange secures with the support.

7. An electric vehicle with a control unit housing comprising:
the housing having surrounding walls for housing electrical components;
a bracket for mounting the control unit, the bracket comprising:
a first bracket member having a body, the body for receiving the control unit, a first end having at least one tab for securing the first member to a support, a second end having at least one coupling flange;
a second member for coupling with the at least one coupling tab;
a slot on the second member for receiving the tab;
a lock on the second member for securing with the tab; and
a body on the second member for positioning the second member with the support.

8. The electric vehicle with a control unit housing of claim 7, wherein the first member body includes posts for receiving the control unit.

9. The electric vehicle with a control unit housing of claim 7, wherein the tab includes an aperture for receiving and securing the lock.

10. The electric vehicle with a control unit housing of claim 7, wherein the lock includes a catch that inserts into an aperture for fastenerless coupling of the first and second members.

11. The electric vehicle with a control unit housing of claim 7, wherein the bracket is cantilevered in the support.

12. The electric vehicle with a control unit housing of claim 7, wherein only the first end flange secures with the support.
